(19) United States
(12) Patent Application Publication
(10) Pub. No.: US 2003/0061329 A1
(43) Pub. Date: Mar. 27, 2003

(54) Method and system for logging data in a cellular data network

(76) Inventor: Gary G. McGrath, Carlsbad, CA (US)

Correspondence Address: Sarah Kirkpatrick, Manager, Intellectual Property Administration, QUALCOMM Incorporation, 5775 Morehouse Drive, San Diego, CA, 92121-1714, US

(21) Appl. No.: 09/966,243

(22) Filed: Sep. 27, 2001

(51) Int. Cl. G06F 15/173

(52) U.S. Cl. 709/223

(57) ABSTRACT

A method and system is presented that provides for a data-logging protocol with stateless connections and atomic commands that is robust, easily debugged, and easily parsed. The data-logging protocol provides for a set of commands and responds for logging data from a data manager to a data server in a cellular data work.

### BACKGROUND

1. Field

The present disclosed embodiments relate generally to communication systems, and more specifically to a method and system for logging data in a cellular data network.

2. Background

Current protocols for logging data in a network are closely designed for specific network managers; therefore, they use some set of proprietary and highly convoluted protocols. Even so, such data-logging protocols do not apply to cellular data networks.

Current data-logging protocols require tight coupling between data clients and data servers, because they each need to share the same knowledge of what data is available, what its format and units are, and other details. Such protocols are mostly binary, making their debugging and testing more difficult, and usually lack atomic operations, making their implementation more complex and less robust. Existing data-logging protocols are based on call or circuit switched models of identifying data, rather than being based on data or IP address approaches, which pertain to cellular data networks.

There is therefore a need in the art for data-logging protocols that provide stateless connections and atomic commands, which are robust and easily debugged. There is also a need for data-logging protocols with rigid command structure, which is easily parsed.

### SUMMARY

The embodiments disclosed herein address the above-stated needs by providing a method and system for logging data in a cellular data network including a data client and a data manager. The method and system provides for sending a command from the data client to the data manager over a network connection, processing the command by the data manager, and sending a response thereto from the data manager to the data client.

In another aspect of the invention, a data manager apparatus for logging data in a network includes a receiver configured to receive a command from a data client over a network connection, a processor configured to process the command, and a transmitter configured to send a response to the data client.

In another aspect of the invention, a data client apparatus for logging data in a network includes a processor configured to generate a command, a transmitter configured to send the command to a data manager over a network connection, and a receiver configured to receive a response from the data manager.

### BRIEF DESCRIPTION OF THE DRAWINGS

FIG. 1 shows a representation of an exemplary network interface for implementing the data-logging protocol, according to one embodiment;

FIG. 2 shows a representation of an exemplary data management control protocol (DMCP) command format;

FIG. 3 shows a representation of an exemplary DMCP response format;

FIG. 4A and FIG. 4B show representations of an exemplary set of DMCP commands;

FIG. 5 shows a representation of exemplary byte values for the DMCP UNITS command;

FIG. 6 shows a representation of an exemplary DMCP command modifier format;

FIG. 7 shows a representation of an exemplary set of DMCP command-modifiers;

FIG. 8 shows a representation of an exemplary data management discovery protocol (DMDP) command; and

FIG. 9 shows a representation of an exemplary embodiment for the data client and data manager operating in FIG. 1.

### DETAILED DESCRIPTION

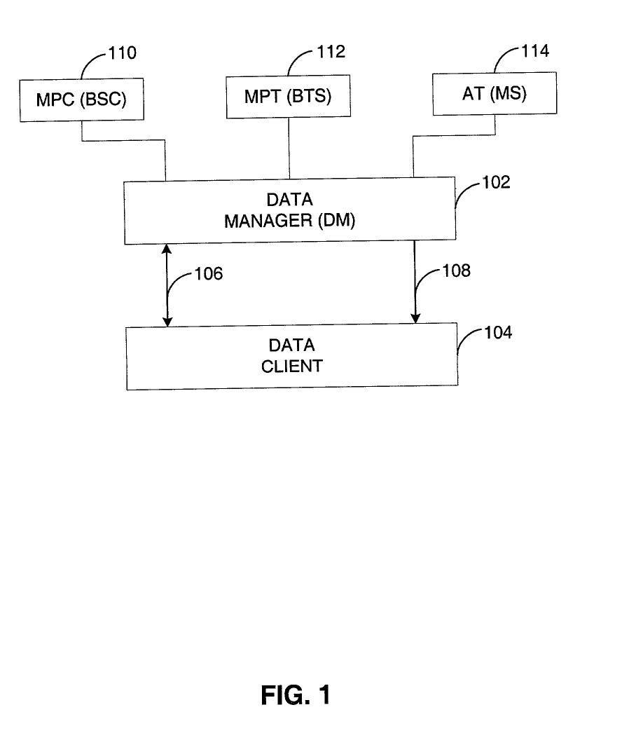

FIG. 1 shows a representation of an exemplary network interface between a data manager 102 and a data client 104, through connections 106 and 108. Data manager 102 may include a network element such as a Web server or an access network (AN). Data manager 102 may be in data communication with data sources such as a modem pool controller (MPC) 110, a modem pool transceiver (MPT) 112, and/or an access terminal (AT) 114. Data client 104 may include a client terminal such as a personal computer, a HDR analysis tool (HAT), or another data server incorporating data from data manager 102 into its own data.

In one embodiment, data communication between data manager 102 and data client 104 may be controlled by two protocols: data manager protocol (DMP) for data control, and binary data exchange format (BDEF) for data delivery. The DMP protocol may include data manager control protocol (DMCP) and data manager discovery protocol (DMDP), as will be discussed later herein.

Data Manager Protocol

The DMP protocol is designed for easy implementation and debugging. The design goals include having the commands atomic and the server connections stateless. An instruction does several things “atomically” when all the things are done immediately, and there is no chance of the instruction being half-completed, being interspersed, or being interrupted. A stateless server treats each request as an independent transaction, unrelated to any previous request. This simplifies the server design because it does not need to allocate storage to deal with conversations in progress or worry about freeing the storage if a client dies in the middle of a transaction. A stateless connection does not suggest that the data manager may not carry state for some registered clients, rather transmission control protocol/Internet protocol (TCP/IP) sessions are made to be stateless to make the overall design more robust to failures. The commands and responses may be in American standard code for information interchange (ASCII), and their format is chosen to make machine parsing easy to implement.

Data manager control protocol (DMCP)

Data manager 102 may support DMCP protocol for sending and receiving DMCP commands, through two-way connection 106, for example. The two-way connection 106 may include TCP or user datagram protocol (UDP) connections. Data manager 102 may use TCP connection for DMCP commands on port 1880. However, if data manager 102 supports DMDP protocol, as defined below, it may also support DMCP protocol on other ports.

In one embodiment, upon receiving a DMCP command on a newly formed TCP connection 106, data manager 102 may hold the connection open until it receives a DONE command, as explained below, or it may time out. A timeout may occur when all the responses to previous commands on an existing connection have been sent, and data manager 102 has waited more than a predetermined period of time, e.g. 30 seconds, for a new command. This timeout may be for the DMCP connection and may not pertain to timeouts associated with other commands, such as the ALIVE command.

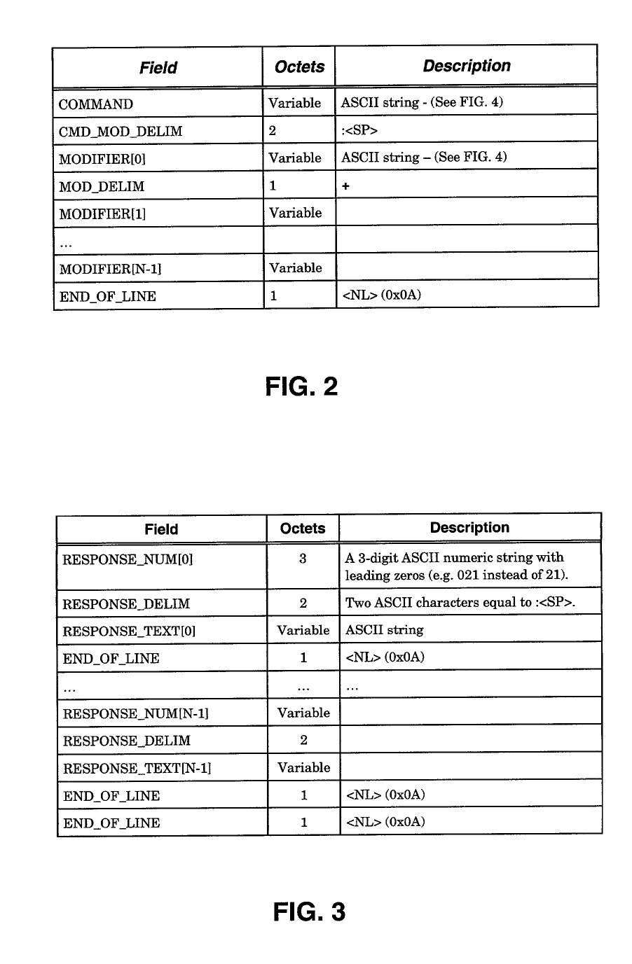

FIG. 2 shows a representation of an exemplary DMCP command format, and FIG. 3 shows a representation of an exemplary DMCP response format. As shown in FIG. 3, the DMCP server may generate several different responses to one command. The responses have to come in the same order as the commands that generate them. Data manager 102 may receive, process, and respond to each command one-by-one or in parallel. In the latter case, data manager has to ensure response order. Data manager 102 may send a response within a predetermined time period, e.g., 30 seconds, of receiving a command.

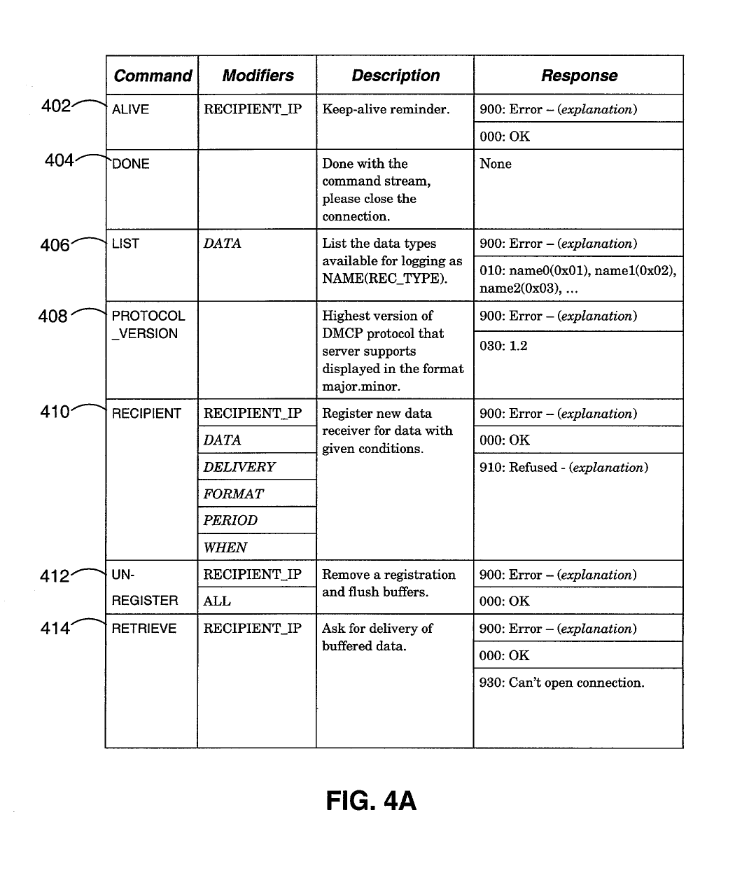

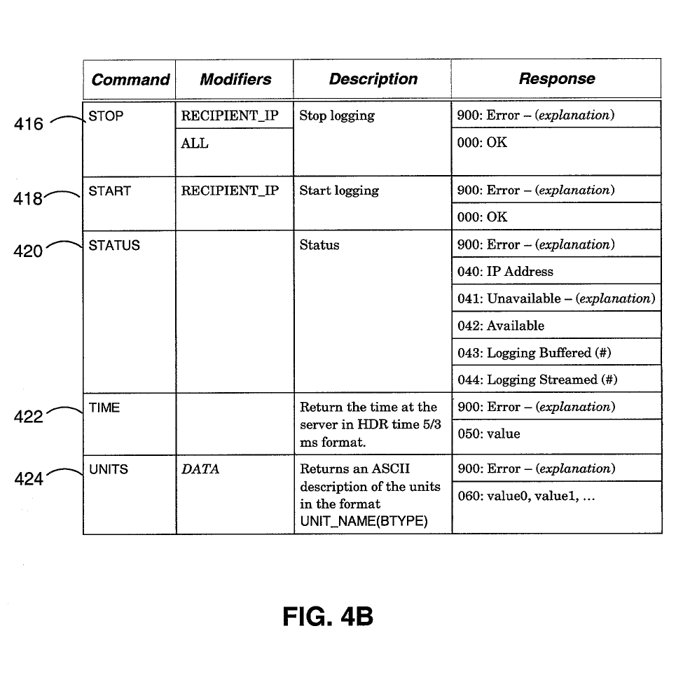

FIG. 4 shows an exemplary set of commands and their possible responses for the DMCP protocol. The commands are explained later in this application. The modifiers shown in italics are optional, and the response items in italics indicate optional text that may be supplied by data manager 102 in response to the corresponding command. In one embodiment, the commands are sent in uppercase characters, but data manager 102 may handle lowercase, uppercase, and mixed case characters.

ALIVE command

Data client 104 sends the ALIVE commands to keep a STREAMED_UDP connection alive, because data manager 102 may not otherwise know that data client 104 is alive or dead. Without this mechanism, data manager 102 may build up a set of UDP streams to a data client that is dead. ALIVE command 402 pertains to the RECIPIENT command when its DELIVERY modifier specifies STREAMED_UDP delivery type, as discussed below. Data is to be delivered real-time (streamed) or buffered locally until requested. Streamed data may be delivered over the network to data client 104 as it comes into data manager 102. There may be two types of streamed logging: STREAMED_TCP and STREAMED_UDP. As their names imply, the former refers to a TCP connection and the latter refers to a UDP connection.

In one embodiment, data client 104 may send ALIVE commands within 30 seconds (18000 slots), for example, from each other or risk data manager 102 timeout that stream. The value of 30 seconds is chosen to ease implementation problems that may occur from the DMCP session timing out between ALIVE commands. Therefore, an STREAMED_UDP real-time application may hold open both its data stream and its DMCP connection by sending ALIVE commands every 30 seconds. However, data client 104 may send commands more often.

DONE command

DONE command 404 finishes an existing command stream so that data manager 102 terminates the connection.

LIST command

LIST command 406 returns the data types available for logging.

PROTOCOL_VERSION command

PROTOCOL_VERSION command 408 returns the highest version of the DMCP protocol that data manager 102 supports.

RECIPIENT command

RECIPIENT command 410 may be used to register a new data client. Multiple RECIPIENT commands having the same full address, i.e. IP address and port number, may be supported. This permits pipelining multiple data requests with different periodicities. Multiple RECIPIENT commands to the same IP address with different port numbers may be also issued by data client 104.

UNREGISTER command

UNREGISTER command 412 removes the registration of data client or clients, which may have been registered through previous RECIPIENT commands. UNREGISTER commands sent for non-registered addresses may be ignored. The RECIPIENT_IP and ALL modifiers for this command may be mutually exclusive.

RETRIEVE command

RETRIEVE command 414 may be issued after a STOP command in order to have data sent to the RECIPIENT_IP specified in the original RECIPIENT command. If a STOP command was not previously issued, the data manager may issue one automatically.

STOP/START commands

STOP command 416 and START command 418 are different from the RECIPIENT command 410, so that logging may be started and stopped multiple times per session. Although both modifiers shown in FIG. 4 for STOP command 416 are in italics, only one of them is required, and they are mutually exclusive.

STATUS command

STATUS command 420 may be used when data client 104 first talks to data manager 102, to get an idea of what the data manager is doing. Data manager 102 may return its status in response. If data manager 102 is currently logging a number of sessions of buffered or streamed data, these numbers may be reported as well.

TIME command

TIME command 422 returns the time at data manager 102. In the case of the HDR network, the time may be the system time expressed in units of 5/3 of one msec, according to one embodiment.

UNITS command

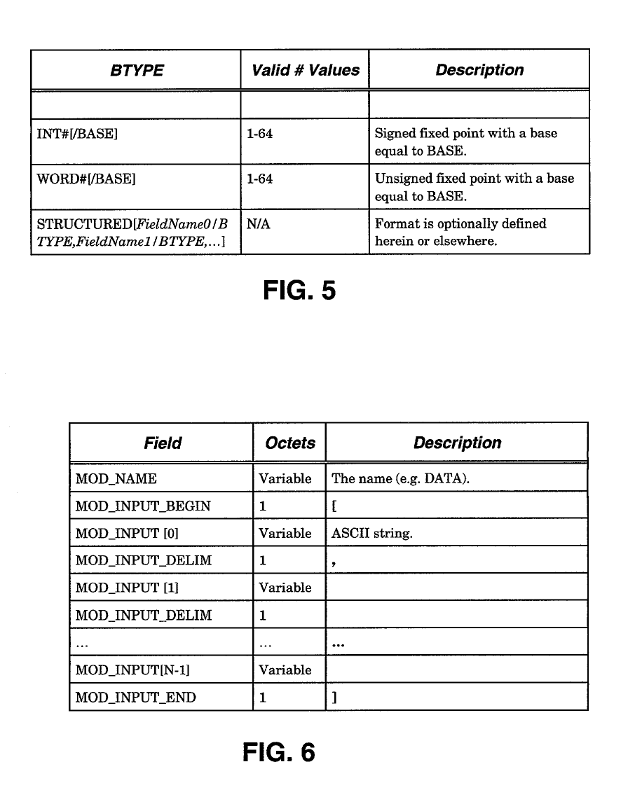

UNITS command 424 is for loosening the coupling between subsystems and data analysis tools. Some examples of a “UNIT_NAME” are: Hz, dB, and Watts. For quantities without units, e.g., structures, UNIT_NAME may be left blank. Data manager 102 may choose to place whatever text is appropriate for the units of the specified data. FIG. 5 shows an exemplary list of valid “BTYPE” values for the UNITS command. The brackets and the information therein are optional. For example, “WORD8” is a valid type, as is “WORD8[/2].” “BASE” is a decimal number representation of a fixed-point denominator. Some examples of the BASE value include 100 or 256. For example, if BTYPE was “WORD8[/128]” and the value of “0x01,” where “0x” denotes the hexadecimal value of the number “01,” was in a record, then the real value is interpreted as “1/128.”

The “STRUCTURED” type may define the structure in network order by giving field name strings and associated BTYPE value pairs separated by commas. The structure definition and the brackets around it are optional. The type “STRUCTURED” implies that the type is defined elsewhere. A BTYPE definition of “STRUCTURED[Field1/WORD8, Field2/INT16]” represents a 3-byte entity, where the first field is an unsigned 8-bit word named “Field1” and the second field is a signed 16-bit word named “Field2”. In one embodiment, the “STRUCTURED” types may not be nested.

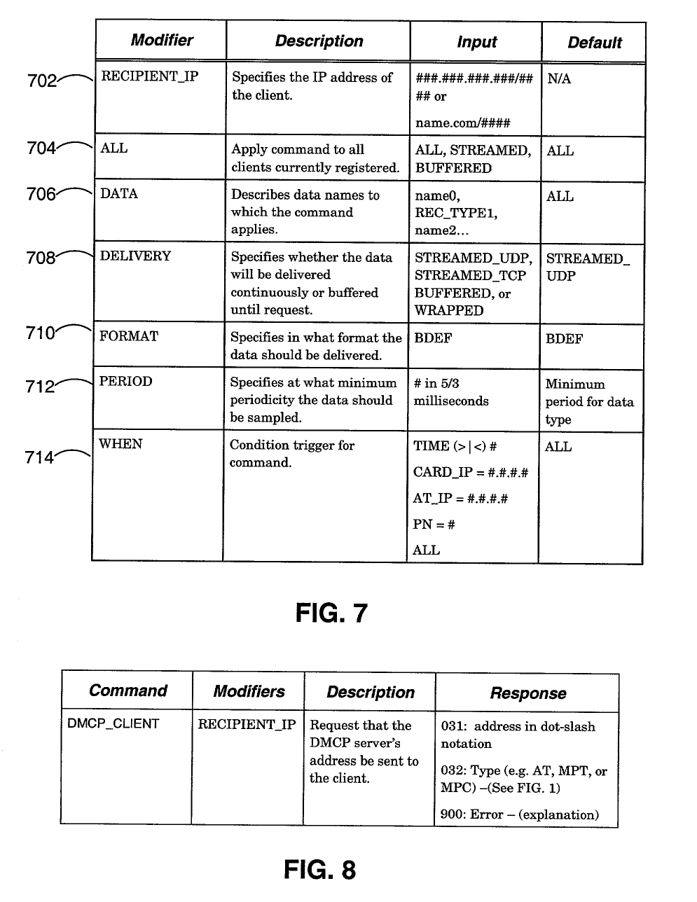

FIG. 6 illustrates an exemplary format for the DMCP commands modifiers. These modifiers may have their input inside brackets. FIG. 7 shows an exemplary set of DMCP modifiers. Duplicate DMCP modifiers may not be allowed, but they may be given in any order.

RECIPIENT_IP modifier 702 specifies the IP address of a data client.

ALL modifier 704 indicates that the command should be applied to all data clients currently registered.

DATA modifier 706 describes the data to which the command applies. A data type may be specified either by attribute names or REC_TYPE value, which may be found in the parenthesis of the LIST command results. Data manager 102 may support DATA lists containing both attribute names and REC_TYPE values.

DELIVERY modifier 708 specifies whether data is to be delivered real-time (streamed) or buffered locally until requested. Streamed data may be delivered over the network to data client 104 as it comes into data manager 102. There may be two types of streamed logging: STREAMED_TCP and STREAMED_UDP. As their names imply, the former refers to a TCP connection and the latter refers to a UDP connection.

The BUFFERED mode may allocate a fixed size buffer to be filled and stop logging data when the buffer runs out of space. The WRAPPED mode may allocate a fixed size buffer as well, but may continuously overwrite the old data as new data comes in. In each of the buffered modes, the size of the buffer may not be negotiated, but may be left up to a subsystem to provide its maximum size. In both buffered cases, the data may be delivered over the TCP connection 106.

PERIOD modifier 712 specifies a minimum periodicity for data manager 102 to sample the data. Data manager 102 may return data with a smaller periodicity (higher rate) if another client has requested the data and the data buffering implementation of data manager 102 allows it. Therefore, data recipients may need to handle data that is returned at a smaller period than requested. On the other hand, data manager 102 may deliver data at the specified PERIOD if it is greater than the minimum periodicity of the data.

WHEN modifier 714 specifies conditions data manager 102 may use them to determine whether the data should be logged. This modifier may allow multiple conditions to be specified together. As with other modifier inputs, the WHEN modifier's inputs may be delimited by a comma. The conditions are evaluated, and they are satisfied, the data may be logged. In one embodiment, multiple conditions may be processed in the following order:

1. If TIME qualifiers are specified, the TIME conditions may need to be met before the remaining conditions are evaluated.

2. If CARD_IP qualifiers are specified, at least one of the CARD_IP conditions may need to be met before the remaining conditions are evaluated. The CARD_IP qualifiers may be used to define the subsystems the data manger is getting data from, e.g., MPC (BSC) 110, MPT (BTS), 112, or AT(MS) 114, as shown in FIG. 1.

3. If AT_IP qualifiers are specified, at least one of the AT_IP conditions may need to be met before the remaining conditions are evaluated.

4. If PN qualifiers are present, at least one of the PN conditions may need to be met. The PN qualifier may be used to define a BTS sector.

If no qualifier is present, an ALL modifier may be assumed. Data manager 102 may not log data that is not associated with the particular AT_IP specified in a WHEN modifier, including those data not associated with any AT. Similarly, if a PN offset is specified as a condition, data not associated with the PN offset may not be logged.

### EXAMPLE

The following example is from the perspective of data client 104 registering with data manager 102. The “(S)” prefix signifies that data client 104 sends a DMCP command string, and “R” signifies that data manager 102 sends a DMCP response string. The exemplary scenario begins after data client 104 connects to a port on data manager 102, e.g., 1880, which is for supporting the DMCP connection 106. Data client 104 may register a real-time display at port 123 to receive a continuous stream of “Type1” and “Type3” data. Data client 104 may also register for buffered logging of “Type4” data to be delivered at a later time to port 124.

(Si) STATUS: <NL>

(Ri) 040: 123.123.123.124<NL>042: Available<NL><NL>

(S2) PROTOCOL_VERSION: <NL>

(R2) 030: 1.2<NL><NL>

(S3) LIST:<NL>

(R3) 010: Type0(0x0), Type1(0x1),Type2(0x2) ype4(0x4)<NL><NL>

(S4) LIST DATA[Type1, Type3]<NL>

(R4) 010: Type1(0x1)<NL><NL>

(S5) TIME<NL>

(R5) 050: 2100031<NL><NL>

(S6) RECIPIENT:DATA[Type1, 0x2]+

(S6) RECIPIENT_IP[123.123.123.123/123]+

(S6) DELIVERY[STREAMED_UDP]+

(S6) WHEN[TIME>2100000,AT_IP=123.123.123.125]+

(S6) FORMAT[BDEF]<NL>

(R6) 000: OK<NL><NL>

(S7) START: RECIPIENT_IP[123.123.123.123/123]<NL>

(R7) 000: OK<NL><NL>

(S8) RECIPIENT:DATA[Type4]+

(S8) RECIPIENT_IP[123.123.123.123/124]+

(S8) DELIVERY[WRAPPED]+

(S8) WHEN[AT_IP=123.123.123.125]+

(S8) FORMAT[BDEF]<NL>

(R8) 000: OK<NL><NL>

(S9) START: RECIPIENT_IP[123.123.123.123/124]<NL>

(R9) 000: OK<NL><NL>

(S10) DONE: <NL>

According to the above example, data client 104 sends the STATUS command (S1), as defined in FIG. 4 (420), and data manager 102 sends the responses (R1), providing the IP address and its availability. Data client 104 also sends the PROTOCOL_VERSION command (S2), as defined in FIG. 4 (408), and data manager 102 sends the responses (R2), providing the version number “1.2”. Data client 104 then sends the LIST command (S3), as defined in FIG. 4 (406), and data manager 102 sends the responses (R3), providing the data types available for logging. Data client 104 may also send the LIST DATA command (S4), as defined in FIG. 4 (406), to determine whether data manager 102 provides data type1 and type2. In response, data manager 102 sends the responses (R4), stating that data “Type1” is available for logging but data “Type3” is not, as also specified in the R3 response. When data client 104 sends the TIME (S5), as defined in FIG. 4 (422), data manager 102 sends the response (R5), providing the time in data manager 102.

To register a new data receiver, data client 104 may send the RECIPIENT command (S6), as defined in FIG. 4 (410), including some modifiers such as DATA, RECIPIENT_IP, DELIVERY, WHEN, and FORMAT, as outlined below:

DATA modifier, as defined in FIG. 7 (706,) specifies the two data types that the data manager 102 may log.

RECIPIENT_IP modifier, as defined in FIG. 7 (702,) specifies the IP address of the data client to which data manager 102 may log data.

DELIVERY modifier, as defined in FIG. 7 (708,) specifies the delivery format “STREAMED_UPD” for the data that may be delivered to the data client 104 continuously on a UDP connection.

WHEN modifier, as defined in FIG. 7 (714,) specifies the conditions that have to be met before logging data, e.g., that the TIME be greater than 2100000 units, and the AT_IP address at a mobile station as specified.

FORMAT modifier, as defined in FIG. 7 (710,) specifies the format of delivering the data, e.g. BDEF.

In response, data manager 102 sends the responses (R6), accepting the command. In one embodiment, data manager 102 may open a one-way UPD connection 108 (FIG.1) for logging data to data client 104. The connection 108 may be a TCP or UDP connection. Data client 104 may then send the START command (S7), as defined in FIG. 4 (418), specifying the IP address in the RECIPIENT_IP modifier. In response, data manager 102 sends the responses (R7), accepting the command.

To register another new data receiver, data client 104 may send another RECIPIENT command (S8), providing the new data type “Type4” and port number “124.” Data client 104 may also provide a new DELIVERY modifier, WRAPPED, specifying that the data be stored locally until it is requested later. In response, data manager 102 sends the response (R8), accepting the command and keeping the connection 108 (FIG.1) open. Data client 104 may then send the START command (S9), specifying the IP address in the RECIPIENT_IP modifier. Data manager 102 sends the response (R9), accepting the command. The data client may then send a DONE command (S10), as defined in FIG. 4 (404), terminating the command stream.

After some time, data client 104 may elect to stop logging “Type1” data and analyzing “Type4” data, which has been buffered. Data client 104 reconnects to data manager 102 to get the buffered data, as outlined below:

(S11) STOP: RECIPIENT_IP[123.123.123.123/124]<NL>

(R11) 000: OK<NL><NL>

(Si2) RETRIEVE: RECIPIENT_IP[123.123.123.123/124]<NL>

(R12) 000: OK<NL><NL>

(S13) DONE: <NL>

According to the above example, data client 104 sends the STOP command (S11), as defined in FIG. 4 (416), commanding data manager 102 to stop logging data to the client at port 124, which had started by START command (S9). Data manager 102 sends the response (R11), accepting the command. Data manager 102 then sends the RETRIEVE command (S12), as defined in FIG. 4 (414), to receive the data that was buffered by the RECIPIENT command (S8).

Data manager discovery protocol (DMDP)

The DMDP protocol commands and responses may have the same format as the DMCP protocol, as presented in FIG. 2 and FIG. 3. However, the DMDP data is sent over an UDP connection, where the DMCP data is sent over a TCP connection. One of the advantages of using UDP over TCP is that a client may broadcast a DMCP_CLIENT message to all data mangers and, thereby locating the active servers. FIG. 8 shows an exemplary DMDP command. Both the “031” and “032” type responses may be given unless there is an error. An exemplary exchange between data client 104 and DMCP data manager 102 may look like this:

(S14) DMCP_CLIENT: RECIPIENT_IP[123.123.123.123/521]<NL>

(R14) 031: 123.123.123.124/1880<NL>032: MPT<NL><NL>

According to this example, data client 104 broadcasts the DMCP_CLIENT command (S14), as defined in FIG. 8, requesting the DMCP data managers to sent their addresses to the given IP address. In response, in this exemplary embodiment, only one data manager identifies its port address “1880” and the subsystem “MPT” the data manager is getting data from.

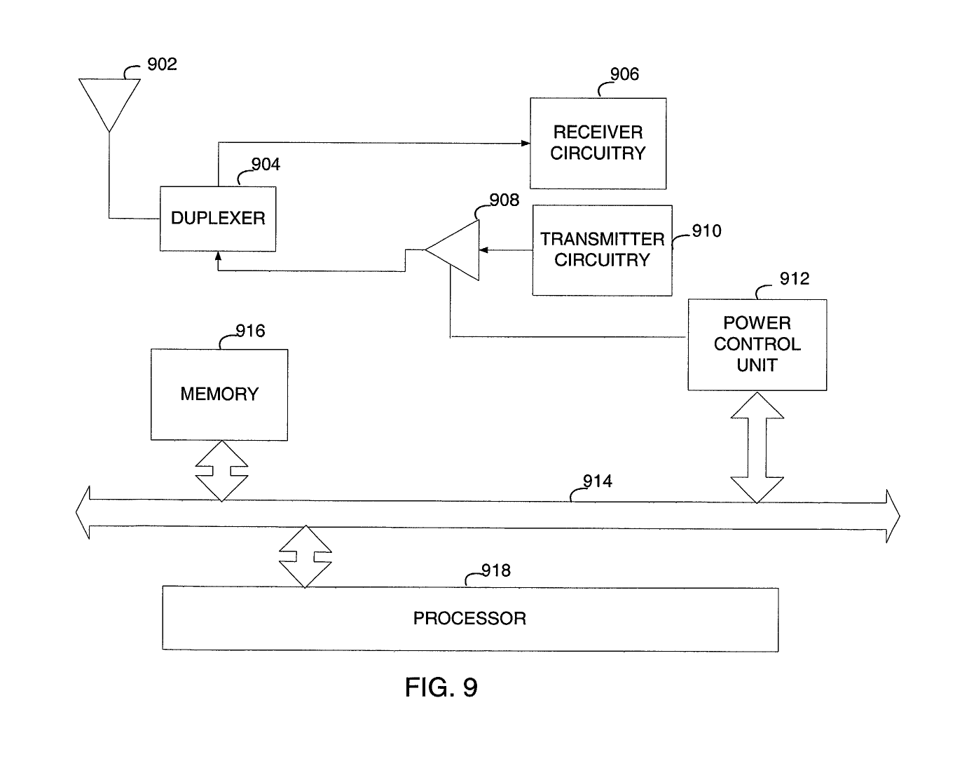

An exemplary embodiment for data client 104, such as a cell phone or a personal digital assistant (PDA), or for data manger 102 operating in system of FIG. 1 is illustrated in FIG. 9. The system in FIG. 9 includes antenna 902 for transmitting and receiving data. Antenna 902 is coupled to duplexer 904 for isolating the receiver path from the transmitter path. The duplexer 904 is coupled to receiver circuitry 906, forming the receiver path, and is coupled to amplifier 908 and transmit circuitry 910 forming the transmitter path. Amplifier 908 is further coupled to power control adjust unit 912 that controls amplifier 908. Amplifier 908 receives the transmission signals from transmit circuitry 910. Received signals via antenna 902 are provided to power control unit 912, which may implements a closed loop power control scheme. Power control unit 912 is coupled to communication bus 914. Communication bus 914 provides a common connection among other modules in FIG. 9. Communication bus 914 is further coupled to memory unit 916. Memory 916 stores computer readable instructions for a variety of operations and functions applicable to data client 104 or data manager 102. The processor 918 performs the instructions stored in memory 914.

Thus, the disclosed embodiments provide for data-logging protocols with stateless connections and atomic commands, which are robust, easily debugged, and easily parsed. The data-logging protocols provide for a set of commands and responds for logging data from a data manager to a data server in a cellular network.

The word “exemplary” is used exclusively herein to mean “serving as an example, instance, or illustration.” Any embodiment described herein as “exemplary” is not necessarily to be construed as preferred or advantageous over other embodiments.

An HDR subscriber station, referred to herein as an access terminal (AT), may be mobile or stationary, and may communicate with one or more HDR base stations, referred to herein as modem pool transceivers (MPTs). An access terminal transmits and receives data packets through one or more modem pool transceivers to an HDR base station controller, referred to herein as a modem pool controller (MPC). Modem pool transceivers and modem pool controllers are parts of a network called an access network. An access network transports data packets between multiple access terminals. The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link. The communication link through which a modem pool transceiver sends signals to an access terminal is called a forward link.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A data manager apparatus for logging data in a network, comprising:
a receiver configured to receive a command from a data client over a network connection;
a processor configured to process the command; and
a transmitter configured to send a response to the data client.

2. The apparatus of claim 1 wherein the processor is configured to keep the network connection alive.

3. The apparatus of claim 1 wherein the processor is configured to keep the network connection closed.

4. The apparatus of claim 1 wherein the processor is configured to provide a list of data types.

5. The apparatus of claim 1 wherein the processor is configured to provide information on a version of a protocol.

6. The apparatus of claim 1 wherein the processor is configured to register a new data client.

7. The apparatus of claim 1 wherein the processor is configured to unregister a data client.

8. The apparatus of claim 1 wherein the processor is configured to provide a buffered data.

9. The apparat us of claim 1 wherein t he processor is configured to stop logging data.

10. The apparatus of claim 1 wherein the processor is configured to start logging data.

11. The apparatus of claim 1 wherein the processor is configured to provide status of the data manager.

12. The apparatus of claim 11 wherein the providing the status includes providing an address of the data manager in the network.

13. The apparatus of claim 11 wherein the providing the status includes indicating availability of the data manager.

14. The apparatus of claim 11 wherein the providing the status includes providing a data-delivery type.

15. The apparatus of claim 14 wherein the data delivery type includes streamed data-delivery type.

16. The apparatus of claim 14 wherein the data delivery type includes buffered data-delivery type.

17. The apparatus of claim 1 wherein the processor is configured to provide time in the data manager.

18. The apparatus of claim 1 wherein the processor is configured to provide unit information of a data.

19. The apparatus of claim 1 wherein the processor is configured to provide an error condition.

20. The apparatus of claim 1 wherein the processor is configured to accept the command.

21. The apparatus of claim 1 wherein the processor is configured to decline the command.

22. A data client apparatus for logging data in a network, comprising:
a processor to generate a command;
a transmitter configured to send the command to a data manager over a network connection; and
a receiver configured to receive a response from the data manager.

23. The apparatus of claim 22 wherein the processor is configured to generate a command for keeping the network connection alive.

24. The apparatus of claim 22 wherein the processor is configured to generate a command for keeping the network connection closed.

25. The apparatus of claim 22 wherein the processor is configured to generate a command for a list of data types.

26. The apparatus of claim 22 wherein the processor is configured to generate a command for a version of a protocol.

27. The apparatus of claim 22 wherein the processor is configured to generate a command to register a new data client.

28. The apparatus of claim 22 wherein the processor is configured to generate a command to unregister a data client.

29. The apparatus of claim 22 wherein the processor is configured to generate a command for providing a buffered data.

30. The apparatus of claim 22 wherein the processor is configured to generate a command for stopping logging data.

31. The apparatus of claim 22 wherein the processor is configured to generate a command for starting logging data.

32. The apparatus of claim 22 wherein the processor is configured to generate a command for providing status of the data manager.

33. The apparatus of claim 22 wherein the processor is configured to generate a command for providing time in the data manager.

34. The apparatus of claim 22 wherein the processor is configured to generate a command for providing unit information of a data.

35. A method for logging data in a network including a data client and a data manager, comprising:
sending a command from the data client to the data manger over a network connection;
processing the command by the data manager; and
sending a response to the command from the data manager to the data client.

36. The method of claim 35 wherein the sending the command includes requesting the network connection be kept alive.

37. The method of claim 35 wherein the sending the command includes requesting the network connection be kept closed.

38. The method of claim 35 wherein the sending the command includes requesting a list of data types.

39. The method of claim 38 wherein the sending the response includes providing the list of data types.

40. The method of claim 35 wherein the sending the command includes requesting information on a version of a protocol.

41. The method of claim 40 wherein the sending the response includes providing the version of the protocol.

42. The method of claim 35 wherein the sending the command includes registering a new data client.

43. The method of claim 42 wherein the sending the command includes providing an address for the new client.

44. The method of claim 42 wherein the sending the command includes providing a data type for the new client.

45. The method of claim 42 wherein the sending the command includes providing a data delivery type for the new client.

46. The method of claim 45 wherein the data delivery includes streamed data delivery type.

47. The method of claim 45 wherein the data delivery type includes buffered data delivery type.

48. The method of claim 42 wherein the sending the command includes providing a data format for the new client.

49. The method of claim 42 wherein the sending the command includes providing a data-sampling rate for the new client.

50. The method of claim 42 wherein the sending the command includes providing a condition for logging data to the new client.

51. The method of claim 35 wherein the sending the command includes requesting a data client to be unregistered.

52. The method of claim 35 wherein the sending the command includes requesting a buffered data.

53. The method of claim 35 wherein the sending the command includes requesting to stop logging data.

54. The method of claim 35 wherein the sending the command includes requesting to start logging data.

55. The method of claim 35 wherein the sending the command includes requesting status of the data manager.

56. The method of claim 55 wherein the sending the response includes sending an address of the data manager in the network.

57. The method of claim 55 wherein the sending the response includes indicating availability of the data manager.

58. The method of claim 55 wherein the sending the response includes indicating a data delivery type.

59. The method of claim 58 wherein the data-delivery type includes streamed data-delivery type.

60. The method of claim 58 wherein the data-delivery type includes buffered data-delivery type.

61. The method of claim 35 wherein the sending the command includes requesting time in the data manager.

62. The method of claim 35 wherein the sending the command includes requesting unit information of a data.

63. The method of claim 35 wherein the sending the response includes indicating an error condition.

64. The method of claim 35 wherein the sending the response includes indicating acceptance of the command.

65. The method of claim 35 wherein the sending the response includes indicating declining the command.

66. An apparatus for logging data in a network including a data client and a data manager, comprising:
means for sending a command from the data client to the data manger over a network connection;
means for processing the command by the data manager; and
means for sending a response to the command from the data manager to the data client.

67. A computer readable medium embodying a method for logging data in a network including a data client and a data manager, the method comprising:
sending a command from the data client to the data manger over a network connection;
processing the command by the data manager; and
sending a response to the command from the data manager to the data client.

68. An apparatus for logging data in a network, comprising:
a memory unit; and
a digital signal processing (DSP) unit communicatively coupled to the memory unit, the DSP unit being capable of:
sending a command from a data client to a data manger over a network connection;
processing the command; and
sending a response to the command to the data client.

69. A method for logging data in a data client, comprising:
sending a command from the data client to a data manger over a network connection; and
receiving a response to the command from the data manager.

70. An apparatus for logging data in a network, comprising:
means for sending a command to a data manger over a network connection; and
means for receiving a response to the command from the data manager.

71. A computer readable medium embodying a method for logging data in a data client, the method comprising:
sending a command from the data client to a data manger over a network connection; and
receiving a response to the command from the data manager.

72. An apparatus for logging data in a network, comprising:
a memory unit; and
a digital signal processing (DSP) unit communicatively coupled to the memory unit, the DSP unit being capable of:
sending a command from the data client to a data manger over a network connection; and
receiving a response to the command from the data manager.

73. A method for logging data in a network, comprising:
receiving a command from a data client over a network connection;
processing the command; and
sending a response to the data client.

74. A computer readable medium embodying a method for logging data in a network, the method comprising:
receiving a command from a data client over a network connection;
processing the command; and
sending a response to the data client.

75. An apparatus for logging data in a network, comprising:
means for receiving a command from a data client over a network connection;
means for processing the command; and
means for sending a response to the data client.

76. An apparatus for logging data in a network, comprising:
a memory unit; and
a digital signal processing (DSP) unit communicatively coupled to the memory unit, the DSP unit being capable of:
receiving a command from a data client over a network connection;
processing the command; and
sending a response to the data client.
